(19) United States
(12) Patent Application Publication
(10) Pub. No.: US 2004/0011606 A1
(43) Pub. Date: Jan. 22, 2004

(54) Road surface braking system

(76) Inventor: Kyu H. Lee, Seongnam (KR)

Correspondence Address: HARNESS, DICKEY & PIERCE, P.L.C., P.O. BOX 828, BLOOMFIELD HILLS, MI, 48303, US

(21) Appl. No.: 10/287,357

(22) Filed: Nov. 4, 2002

(30) Foreign Application Priority Data
Jul. 22, 2002 (KR) 2002-42855

(51) Int. Cl. F16D 65/52

(52) U.S. Cl. 188/200

(57) ABSTRACT

Disclosed is a road surface braking system for an automobile which is totally different in conception and structure from the prior art. The braking system includes a hydraulic source, an on/off hydraulic source operating switch which puts the source into an operative state or a non-operative state, a piston device connected to the source such that it can be operated to be extended and withdrawn in response to the amount of force applied from the source and can be driven by the source, and a road surface braking member connected to the piston device such that it can be contacted and separated from the road by the piston device and can be driven by the piston device. Also, the braking system further includes a switch controlling device for controlling the on/off hydraulic source operating switch so that the hydraulic source can be operated only under certain predetermined conditions.

### BACKGROUND OF THE INVENTION

1. Field of the Invention

The invention relates to a brake apparatus for an automobile, and more particularly to an improved road surface braking system for an automobile.

2. Description of the Related Art

The brake apparatus is an indispensable part of an automobile. Since the inception of the automobile, many efforts have been made by the automobile industry to improve the overall performance of an automobile, which includes increasing the braking force of the brake apparatus. As a result, a variety of the brake apparatuses for the automobile are known in the related art.

Modern brake apparatuses are focused to achieve instantaneous stopping of the tires of an automobile when the driver simultaneously presses on the foot brake. However, such brake apparatuses have the following disadvantages.

During normal traveling conditions, problems and disadvantages of a typical automobile braking system rarely occur. However, when driving under severe conditions, such as heavy snow or rain, it is almost unavoidable that when the brakes of an automobile are applied, the automobile will rotate in an unintentional direction or the tires will skid on the snowy or rainy road, even if the automobile is equipped with ABS (anti-lock brake system).

In addition, problems exist when it is necessary to make sudden stops while traveling at high speeds. In such an event, it is unavoidable that the automobile will slide over a distance that is proportional to the speed that the automobile is traveling under.

Finally, problems exist when an emergency brake is used when parking an automobile on a sloped surface. Automobiles that are parked in such positions often slip due to the force of gravity resulting from the slope when an external force is applied to the automobile.

### SUMMARY OF THE INVENTION

It is an object of the present invention to solve the problems involved in the above related art, and to provide a totally novel road surface braking system for an automobile.

Another object of the present invention is to provide road surface braking system for an automobile that is capable of stopping the automobile in a very short amount of time without the automobile sliding over a long distance when brakes are applied suddenly at high speeds or under severe driving conditions such as snow or rain.

Still another object of the present invention is to provide a road surface braking system for an automobile that is capable of preventing the automobile from slipping while parked and/or stopped on a sloped surface, by applying a better braking force to the automobile.

To achieve these objects and other advantages in accordance with the purpose of the invention as embodied and broadly described herein, a road surface braking system for an automobile utilizes a totally different concept and structure from that which is used in the prior art. In addition to a conventional foot brake or emergency brake, the invention provides a separate road surface braking system for an automobile comprising an additional braking member for further braking the automobile by use of friction resulting from contact between the braking member and the road.

In one aspect of the present invention, a road surface braking system comprises a driving source, an on/off driving source operating switch which puts the driving source into an operative state or a non-operative state, a piston device connected to the driving source such that it can be operated to be extended and withdrawn in response to a force applied from the driving source and can be driven by the source, and a road surface braking member connected to the piston device such that it can be contacted and separated from the road by the piston device and can be driven by the piston device.

According to the invention, the driving source is made to be operated in response to pressure applied by a foot brake while the on/off driving source operating switch is in the on state.

According to the invention, it is preferable that the pressure applied by the foot brake, such as during a sudden stop, is detected and the driving source is made to be operated only if a value of the detected pressure is greater than a predetermined value. In order to effectuate this purpose, according to one of the embodiments of the invention, a separate device for detecting the pressure applied by the foot brake is provided.

In addition, it is preferable to provide a separate timing device for measuring the time after the foot brake is pressed on. Thus, the driving source is preferably made to be operated only if the measured time is greater than a predetermined time. Accordingly, the road surface braking system of the invention can be made to adapt to the driver's habit of frequently pressing on the brake.

In another aspect of the present invention, a road surface braking system comprises a driving source, an on/off driving source operating switch which places the source into an operative state or a non-operative state, a piston device connected to the source such that it can be operated to be extended and withdrawn in response to a force applied from the source and can be driven by the source, a road surface braking member connected to the piston device such that it can be contacted and separated from the road by the piston device and can be driven by the piston device, and a switch controlling device for controlling the on/off driving source operating switch so that the driving source can be operated only under certain predetermined conditions.

According to the invention, the switch controlling device preferably comprises a sensor for controlling the operation of the on/off driving source operating switch.

During normal driving, the sensor of the switch controlling device senses the state of the normal driving, so that even if the on/off driving source operating switch is in the on state, it controls the on/off driving source operating switch not to operate the driving source. Accordingly, the piston device is not operated, even if the driver pushes the foot brake. Only the conventional braking apparatus works, and the road surface braking member of the invention does not move towards the road. However, under severe driving conditions, if the driver turns on the operation of the switch controlling device, e.g. by a simple switch manipulation, the driving source is operated by the on/off driving source operating switch in the on state when the foot brake is pressed. As a result, the piston device is operated, and thus the road surface braking member of the invention moves towards the road, contacts the road, and eventually applies further braking force to the automobile.

According to the invention, the switch controlling device can be manipulated (e.g. by a separate switch) in the automobile or made to be operated automatically.

According to the invention, it is preferable that the on/off driving source operating switch is mounted in a convenient place for the driver to easily manipulate. For example, it can be mounted near or at the place that the window manipulating device (or switch) is mounted.

In the embodiment of the invention, it is preferable that both the on/off driving source operating switch and the switch controlling device can be in the on state when starting the automobile engine.

In the embodiment of the invention, the situation may arise where the driver must make a sudden stop at high speeds. In such situations, drivers will each have different capabilities for executing such a sudden stop. Also, when the automobile is stopped suddenly, the pressure applied by the foot brake is normally much greater than that during normal driving. Thus, as the first embodiment of the invention, a separate device for sensing the pressure applied by the foot brake is provided for the purpose of automatically breaking the operation of the switch controlling device, without manually executing such an action, when the pressure applied by the foot brake exceeds a certain threshold.

In the embodiment of the invention, the driving source is a hydraulic source.

According to the invention, the road surface braking member may be a single-type or multiple-type member.

According to the invention, the road surface braking member has a shape such that it gives a friction force sufficient to stop the automobile. For example, the road surface braking member may be saw-toothed or in the shape of a hook.

In addition, it is preferable that the road surface braking member is made of high-strength material suitable for giving enough friction to stop the automobile while contacting and scraping the road.

In the embodiment of the invention, it is preferable that a road surface braking member sensing device is mounted at a convenient place in the automobile, in order to easily confirm whether the road surface braking member is in the normal state (e.g. the state of the on/off driving source operating switch being off, or the state of the switch controlling device being operative; that is, the stationary state is one that the road surface braking member is separated from the road) or in the state of applying a braking force to the automobile while it contacts the road (e.g. the state of the on/off driving source operating switch being on and/or the state of the switch controlling device being non-operative). Such a sensing device may have an indicating function of visually showing the state of the road surface braking member or an alarming function for audible notification of the state of the braking member.

### BRIEF DESCRIPTION OF THE DRAWINGS

The objects, features and advantages of the present invention will become more apparent from the following detailed description of the preferred embodiments thereof with reference to the accompanying drawings, in which:

FIG. 1 illustrates a road surface braking system according to the preferred embodiment of the present invention;

FIG. 2 illustrates a road surface braking system according to another preferred embodiment of the present invention;

FIG. 3 illustrates a state of the road surface braking member of the road braking system when the invention is mounted in the automobile;

FIG. 4 illustrates a state of the road surface braking member of the road surface braking system when the invention is operative; and

FIGS. 5a to 5f illustrates the embodiments of the road surface braking member of the road surface braking system according to the invention.

### DETAILED DESCRIPTION OF THE EMBODIMENT

Hereinafter, preferred embodiments of the present invention will be described in detail with reference to the accompanying drawings. In the following description of the present invention, a detailed description of known functions and configurations incorporated herein will be omitted when doing so might make the subject matter of the present invention unclear.

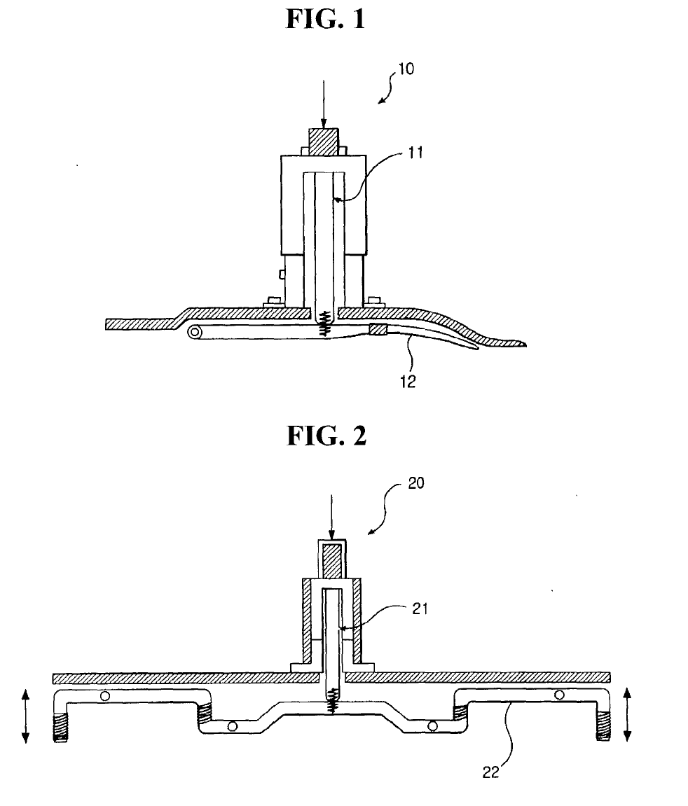

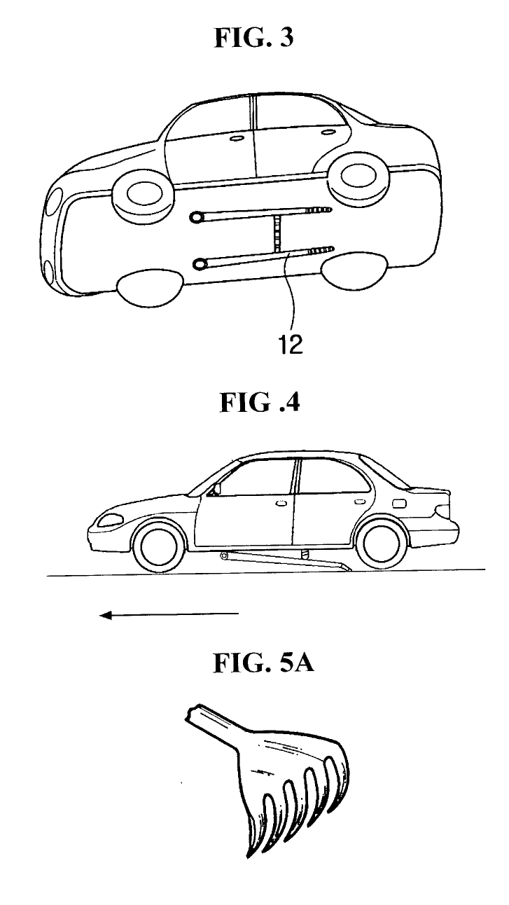

FIG. 1 schematically shows a road surface braking system according to the present invention. FIG. 3 illustratively shows the state that the road braking system when mounted at the underside of the automobile. In the following description of the present invention, the construction of the circuits, which allow a driving source to be operated when pressure is applied by the foot brake are very well known to those skilled in the art. Thus, the detailed description thereof is omitted.

A road surface braking system 10 according to the invention comprises a hydraulic source (not shown) and a piston device 11 connected to the hydraulic source. A road surface braking member 12 is connected to the piston device 11 by a spring. According to one embodiment of the invention, the piston device 11 is constructed such that when the braking operation is started, it moves downwardly, as seen in the drawings, by a hydraulic pressure applied from the hydraulic source. As a result, the piston device 11 pushes the road surface braking member 12 towards the road with a great deal of force.

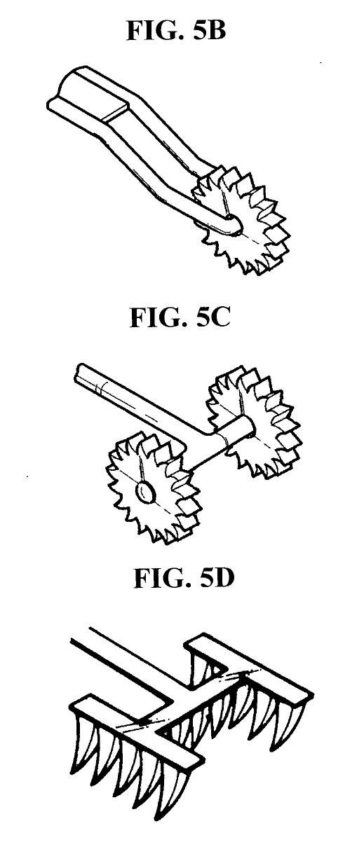

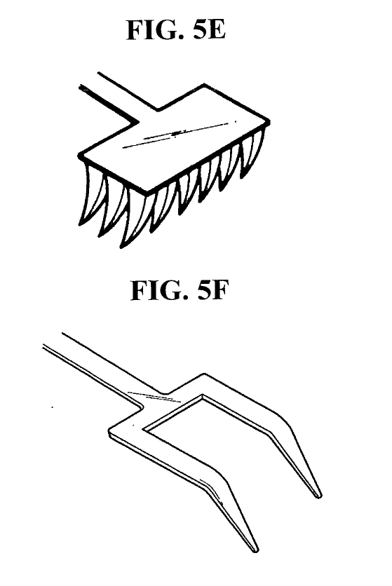

According to the invention, the road surface braking member 12 is made such that it directly contacts the road, and thus applies a considerable braking force to the automobile when the brakes are applied. The detailed shapes and structures of such a road surface braking member are illustratively shown in FIG. 5a to FIG. 5f. As seen in these figures, the road surface braking member 12 has certain structures and shapes that allow it to be driven into the contacting road causing a great amount of friction when it makes contact with the road.

More specifically, when the road surface braking system 10 is operated and the road surface braking member 12 makes contact with the road, the member does not only exert a braking force by simply being dragged along the road. Rather, the member applies a considerable amount of force to the road by the force supplied from the hydraulic source, which causes the member to scrape and create grooves in the road. As a result, a powerful braking force, which is not comparable to the prior art, is generated. Accordingly, even if the brakes of an automobile are used under severe conditions, such as snow or rain, it is possible to stop the automobile in a very short time without having the automobile slide over a long distance. In addition, when the automobile is parked on a sloped road or a flat road, it is possible to prevent the automobile from slipping and/or from being stolen, and the tires of the automobile are fixed not to move due to the emergency brake, since the road surface braking member 12 of the above-mentioned structures makes contact with the road.

Preferably, the road surface braking member 12 is made of a high-strength material capable of providing a braking force that is sufficient enough to stop the automobile when the member makes contact with the road.

The road surface braking member may be single-type (refer to FIG. 1) or multiple-type member in order to enhance the braking effect, as can be seen in FIG. 2.

The road surface braking system according to the invention comprises an on/off hydraulic source operating switch (not shown) which puts the driving source into an operative state or a non-operative state. In addition, according to the preferred embodiments of the invention, the road surface braking system further comprises a switch controlling device (not shown) for controlling the on/off hydraulic source operating switch so that the driving source cannot be operated, even if the foot brake is applied during normal driving of the automobile and is operational only under certain predetermined conditions. The switch controlling device comprises a sensor in order to achieve the purpose above.

The on/off hydraulic source operating switch may be made to automatically be in the on or the off state when the engine of the automobile is started or terminated. Also, the on/off hydraulic source operating switch may be manually made to be in the on or the off state. Accordingly, it is preferable that the on/off hydraulic source operating switch is mounted in a convenient place so that the driver can easily manipulate it. For example, it can be mounted near or at the place that the window manipulating device (or switch) is mounted.

Also, it can be made that the operation of the switch controlling device is controlled by a simple switch in the automobile. According to the preferred embodiment, the switch controlling device is automatically put in the on state when starting the automobile.

Additionally, one preferred embodiment of the present invention provides a road surface braking member sensing device for preventing the automobile from being driven while the road surface braking member 12 is in contact with the road or for easily confirming whether the road surface braking member is in the normal state or not. Such a sensing device may be made to visually show or audibly notify the state of the road surface braking member.

The operation of the road surface braking system is described in more detail below.

When starting the automobile engine, the on/off hydraulic source operating switch of the road surface braking system 10, 20, according to one embodiment of the invention, is automatically in the on state. (Naturally, the on/off hydraulic source operating switch may be manually put in the on state by hand.) Accordingly, when the brake is applied in order to stop the automobile during normal driving, the hydraulic source is driven in response to the brake pressure. Thus, the piston device 11 is operated, as a result of the road surface braking member 12 moving towards and making contact with the road, thereby applying a considerable braking force to the automobile. Then, after the driver puts the on/off hydraulic source operating switch into the off state, but before pushing on the accelerator for driving the automobile, the piston device 11 and the road surface braking member 12 are returned to their original positions. The driver then puts the on/off hydraulic source operating switch in the on state and keeps the hydraulic source in the state of being operated when the brake is pressed on.

In the above embodiment of the invention, the road surface braking system 10, 20 is operated only if a certain amount of pressure is applied by the brake during a sudden stop or if a predetermined amount of time elapses after the foot brake is pressed on. Preferably, a separate device for detecting the amount of pressure applied by the foot brake or a separate timing device for measuring the time after the foot brake is pressed on is provided, in order to prevent the road surface braking system of the invention from being operated when a small amount of brake pressure is applied or when brake pressure is applied for only a short time.

According to another embodiment of the road surface breaking system, when the engine is started, the on/off hydraulic source operating switch and the switch controlling device are automatically in the on state when the engine is started. Of course, the operating switch and the switch controlling device can be in the on state by a simple manual switch as explained above.

Since the switch controlling device is in the on state, during normal driving speed, the sensor of the switch controlling device senses the driving state, and thus controls the hydraulic source operating switch, which is in the on state, not to operate the hydraulic source. The purpose is for the hydraulic source not to be operated even if the brake is applied by the driver. Accordingly, when the brake is applied for stopping the automobile, such a stop is accomplished only by the conventional brake apparatus.

However, during heavy rain or snow, the automobile is likely to slide over a long distance due to the slickness of the road when the driver applies the brake. Accordingly, an additional braking force for preventing such sliding is needed. Such needs are achieved by the road surface braking system according to the invention. Under the above-mentioned conditions, if the driver breaks the operation of the switch controlling device by manipulating a separate switch mounted at a convenient place in the automobile (or when the automobile is brought to a sudden stop during high traveling speeds, the brake pressure sensing device senses that the pressure applied by the brake exceeds a certain predetermined pressure, and thus releases the operation of the switch controlling device). Under such circumstances, the hydraulic source operating switch, which is in the on state, is now capable of operating the hydraulic source. In such a state, if the driver applies the brake, the hydraulic source will operate at the moment the automobile brake is applied in a conventional manner, and a hydraulic pressure supplied from the operating hydraulic source will be applied to the piston device 11. As a result, the piston device 11 is driven towards the road, thereby causing the road surface braking member 12 to make contact with the road with a great deal of force. The automobile will then come to a stop within a very short period of time (refer to FIG. 4). Accordingly, it is possible to prevent the automobile from sliding over a long distance or from rotating in an undesirable direction due to slippery road conditions or high traveling speeds in braking the automobile. Consequently, the driver will be protected against traffic accidents. After the stop is accomplished, the driver may place the hydraulic source operating switch into the off state before accelerating the automobile. Since the piston device 11 is then withdrawn into its original position, the road surface braking member 12 correspondingly returns to its normal mounting position. It is then sufficient to put both the switch controlling device and the on/off hydraulic source operating switch into the on states.

While the present invention has been described and illustrated herein with reference to the certain preferred embodiments thereof, it will be understood by those skilled in the art that various changes in form and detail may be made therein without departing from the spirit and scope of the invention as defined by the appended claims. For example, the switch controlling device can be made so that its operations are automatically broken by a separate device such as a programmed circuit containing information on the conditions of the road surface, the weather, and the traveling speed of the automobile, etc., or by a sensor capable of sensing such conditions, thereby operating the on/off driving source operating switch. Also, in the above embodiments, it is described that the piston device is moved vertically to operate the road surface braking member. However, it will be understood that the piston device may be fitted up horizontally to operate the road surface braking member. The appended claims must be construed to cover all such modified examples.

What is claimed is:

1. A road surface braking system comprising
a driving source;
an on/off driving source operating switch which puts the driving source into an operative state or a non-operative state;
a piston device connected to the driving source such that it can be operated to be extended and withdrawn in response to a force applied from the driving source and can be driven by the driving source; and
a road surface braking member connected to the piston device such that it can be contacted and separated from the road by the piston device and can be driven by the piston device.

2. The road surface braking system according to claim 1, wherein the driving source is made to be operated in response to pressure applied by a foot brake under condition that the on/off driving source operating switch is in an on state.

3. The road surface braking system according to claim 2, further comprising a separate device for sensing pressure applied by the foot brake and a separate timing device for measuring a time after the foot brake is pressed on, wherein the driving source is made to be operated only if a value of the detected pressure is greater than a predetermined value or the measured time is greater than a predetermined time.

4. A road surface braking system comprising
a driving source;
an on/off driving source operating switch which puts the driving source into an operative state or a non-operative state;
a piston device connected to the source such that it can be operated to be extended and withdrawn in response to a force applied from the source and can be driven by the driving source;
a road surface braking member connected to the piston device such that it can be contacted and separated from the road by the piston device and can be driven by the piston device; and
a switch controlling device for controlling the on/off driving source operating switch so that the driving source can be operated only under certain predetermined conditions.

5. The road surface braking system according to claim 4, wherein the switch controlling device comprises a sensor for controlling the operation of the on/off driving source operating switch.

6. The road surface braking system according to claim 4 or 5, wherein the switch controlling device in the operative state breaks the operation of the on/off driving source operating switch.

7. The road surface braking system according to claim 4 or 5, wherein the driving source is made to be in an operative state with the switch controlling device being in a non-operative state and the on/off driving source operating switch being in the on state.

8. The road surface braking system according to claim 4 or 5, wherein the switch controlling device is automatically in an operative state at the moment the automobile is started.

9. The road surface braking system according to claim 4 or 5, wherein the switch controlling device may be manually put in an operative state or a non-operative state.

10. The road surface braking system according to claim 9, further comprising a separate switch for manipulating the switch controlling device in the automobile.

11. The road surface braking system according to claim 4 or 5, further comprising a separate device for sensing the pressure applied by the foot brake, wherein the operation of the switch controlling device is broken when a value of the detected pressure measured exceeds a predetermined value.

12. The road surface braking system according to claim 1 or 4, wherein the driving source is a hydraulic source.

13. The road surface braking system according to claim 1 or 4, wherein the road surface braking member is a single-type or multiple-type braking member.

14. The road surface braking system according to claim 13, wherein the road surface braking member is saw-toothed or in the shape of a hook.

15. The road surface braking system according to claim 13, wherein the road surface braking member is made of a high-strength material.

16. The road surface braking system according to claim 1 or 4, wherein the on/off driving source operating switch is mounted near or at the place that a window manipulating device is mounted.

17. The road surface braking system according to claim 16, wherein the on/off driving source operating switch is manually manipulated.

18. The road surface braking system according to claim 1 or 4, wherein the on/off driving source operating switch is in the on state at the moment the automobile is started.

19. The road surface braking system according to claim 1 or 4, further comprising a sensing device for confirming the state of the road surface braking member.

20. The road surface braking system according to claim 18, wherein the sensing device has a visual indicating function or an audible alarming function.
